(19) United States
(12) Patent Application Publication
(10) Pub. No.: US 2008/0180275 A1
(43) Pub. Date: Jul. 31, 2008

(54) Communication System For Multi-Tiered Network

(75) Inventors: Michael K. Whitaker, Humble, TX (US); William K. Mathews, Houston, TX (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Cimarron Systems, LLC, Humble, TX (US)

(21) Appl. No.: 11/668,588

(22) Filed: Jan. 30, 2007

(51) Int. Cl. G08C 15/06

(52) U.S. Cl. 340/870.03

(57) ABSTRACT

An automated meter reading system and communications network. The system comprises a multi-tiered network for obtaining information from utility meters and communicating the information to a central database. A plurality of terminal units are each operatively connected to a utility meter to sense operational data of the utility meter and transmit the data through the network when polled. A plurality of primary units are each operatively connected to a utility meter to sense operational data of the utility meter and transmit the data through the network. The primary units also request data from one or more of the terminal units by polling the terminal units, and transmit that data through the network. Data collection units receive data from the primary units and transmit the data to a central host computer. The network is configurable so that status information or requests can be transmitted from the terminal units to the host computer or from the host computer to any of the terminal units.

### FIELD OF THE INVENTION

The present invention relates generally to the field of communication networks for communicating data from a plurality of data units to a centralized data collection unit, and, more particularly, to communicating data in an automated utility meter reading system.

### SUMMARY OF THE INVENTION

The present invention is directed to a multi-tiered communications network for an automated utility meter reading system. The network comprises a plurality of terminal units, at least one primary unit, and at leas one data collection unit. Each terminal unit is operatively coupled to a utility meter and comprises a sensor assembly adapted to detect operational data of the utility meter operatively coupled to the terminal unit, a data transmitter adapted to transmit the operational data, and a terminal receiver assembly adapted to receive communications. The at least one primary unit is operatively coupled to a utility meter and comprises a sensor assembly adapted to detect operational data of the utility meter operatively coupled to the primary unit, a primary receiver assembly adapted to receive the terminal unit operational data from at least one terminal unit, and a primary transmitter adapted to send command information to the at least one terminal unit and to transmit the operational data from the sensor assembly and the terminal unit operational data. The at least one data collection unit comprises a data receiver assembly adapted to receive the operational data from at least one primary unit and a collection unit transmitter adapted to send command information to the at least one primary unit. Each terminal unit in the network associates itself with a particular primary unit by receiving command information from the particular primary unit, the command information comprising a polling time and a polling interval. The network is designed such that if a particular terminal unit fails to communicate with its associated primary unit at the polling time, then the particular terminal unit associates itself with a different primary unit.

The invention is further directed to a method for communicating information in an automated meter reading system. The method comprises the steps of transmitting an association signal from each of a plurality of terminal units, transmitting a command signal comprising a poll time and a poll interval from a single primary unit to a particular terminal unit in response to receiving the association signal from the particular terminal unit, transmitting a polling signal from the primary unit to the particular terminal unit at the poll time, transmitting a data signal from the particular terminal unit to the primary unit in response to the polling signal, and transmitting a second association signal from the terminal unit if a polling signal is not received at the terminal unit.

### BRIEF DESCRIPTION OF THE DRAWINGS

FIG. 1 is a schematic illusion of a multi-tiered communications network built in accordance with the present invention.

FIG. 2 is a schematic illustration of a remote terminal unit for use with the present invention.

### DESCRIPTION OF THE INVENTION

Automated meter reading systems are known in the industry. Generally, meter reading units sense meter operational data and communicate that data to a central database. The communication network and protocols generally involve transmitting redundant information and inefficient techniques. The present invention provides a multi-tiered wireless network with cost-effective units and efficient communication protocols.

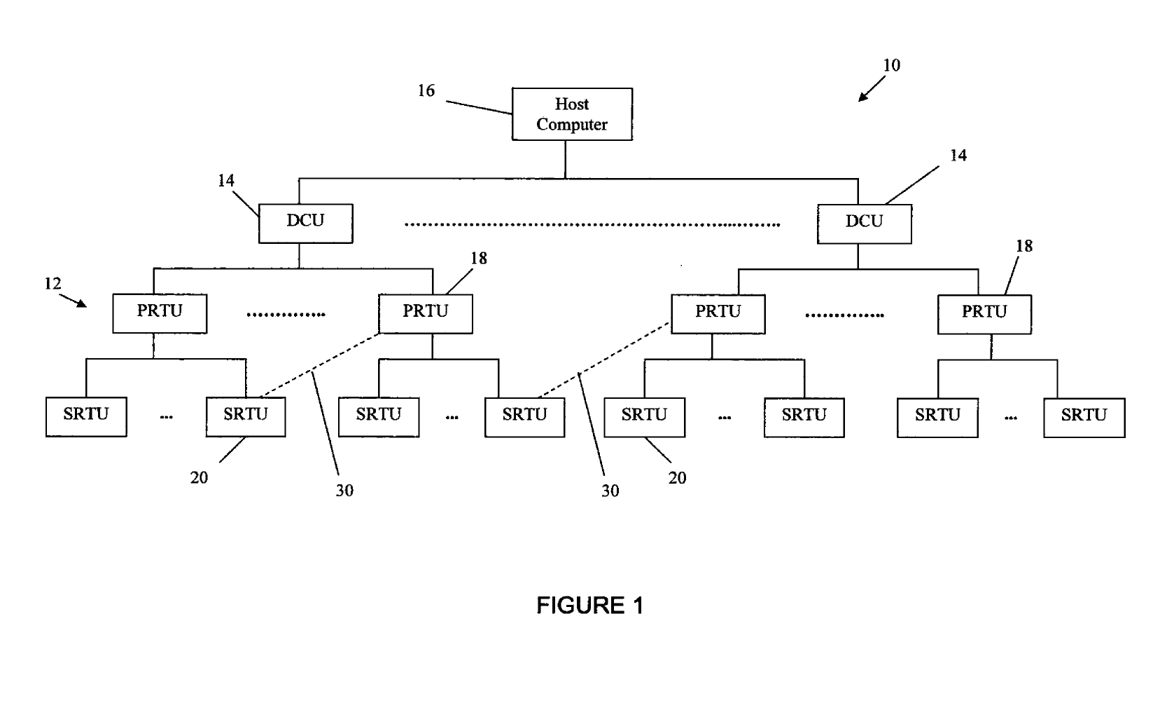

With reference now to the drawings in general and to FIG. 1 in particular, there is shown therein a schematic representation of a network 10 constructed in accordance with the present invention. The proposed system is a multi-tiered, fixed, wireless network 10, preferably for use with an automated meter reading system. The network 10 comprises a plurality of remote terminal units 12, a plurality of data collection units 14, and a Host Computer 16. In the multi-tiered network of the present invention, operational data is obtained by the plurality of terminal units 12, transmitted to the data collection units 14, and ultimately received at the Host Computer 16. Preferably, transmissions are accomplished using a frequency hopping spread spectrum (FHSS) radio system operating in the unlicensed ISM band. The transmissions, including all data communications, will ordinarily occupy only several milliseconds of time. The transmissions will also preferably include a message header with information to identify where the transmission is from and who the intended recipient is.

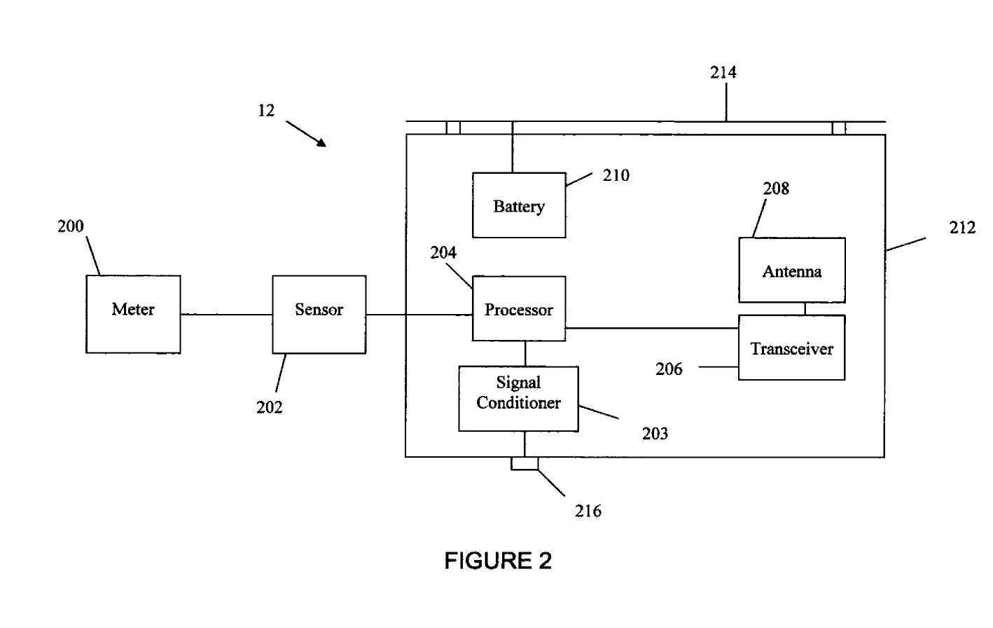

Referring now to FIG. 2, there is shown therein a schematic representation of the remote terminal units 12. Each of the plurality of remote terminal units (RTUs) 12 is preferably positioned proximate a utility meter 200 and will be operably coupled to the utility meter. The utility meter may be a gas, water, or electric meter. Each RTU comprises a sensor assembly 202, a signal conditioning module 203, a microprocessor 204, a radio transceiver 206, an antenna 208, and a battery 210. The sensor assembly 202 is adapted to sense and record operational data of the respective utility meter 200. The operational data preferably includes an accumulated meter pulse total for consumption data and a tamper status. The signal conditioning module 203 may be used to sense other auxiliary data such as pressures, temperatures, or cathodic protection device voltages. Preferably, the signal conditioning module 203, microprocessor 204, the transceiver 206, the antenna 208, and the battery 210 are contained in a separate housing 212 and are operatively connected to the sensor assembly 202. Installation of the RTU 12 may be accomplished by replacing an old index on the meter 200 with the sensor assembly 202 of the RTU and attaching the separate housing 212 adjacent the meter.

The sensor assembly 202 preferably comprises a modified meter index, which may include a magnet mounted to an index drive shaft on the meter 200, a magnetic reed switch, and a tamper switch. In the preferred embodiment, when the magnet on the index drive shaft comes near the reed switch, the switch closes, applying a voltage to an input terminal on the microprocessor 204. The microprocessor 204 detects the change in voltage and increments a pulse count by one. The microprocessor 204 inputs are CMOS gates so that the only current involved in the pulse detection is that used to charge the gate capacitance, which is on the order of nano-amperes. This helps keep the power consumed by the RTU 12 extremely low.

In the preferred embodiment, there are two types of RTUs 12—Primary and Secondary. Preferably, each Primary RTU (PRTU) 18 will associate with one or more Secondary RTUs (SRTU) 20 in a manner yet to be described. Each PRTU 18 polls the plurality of SRTU 20 associated with it on a periodic basis. When polled, each SRTU 20 transmits operational data collected at its respective meter, along with a battery status, to the polling PRTU 18. The number of SRTUs 20 associated with each PRTU 18 is function of the radio range and meter density. Tests conducted in an urban area indicate that a range of up to 1370 feet (418 meters) can be achieved with less than 300 mW of power.

Each of a plurality of SRTUs 20 communicates with a particular PRTU 18 after associating with the PRTU. When a SRTU 20 is installed, the SRTU begins periodically broadcasting a hello message. All PRTUs 18 within range of the SRTU 20 respond to the hello message. The SRTU 20 selects the PRTU 18 communicating with the greatest signal strength and associates itself with that PRTU by communicating an association signal to the PRTU. The PRTU 18 will then transmit a command signal to the SRTU 20. The command signal preferably comprises an initial poll time, a poll interval, and a frequency channel number. The PRTU 18 also communicates its clock information to the SRTU 20 so that the SRTU may initialize its real time clock. The SRTU 20 then enters a low power mode and waits for the designated poll time. In the low power mode, the processor 204 turns off its transceiver 206 and signal conditioning module 203 and then enters the low power mode. If at any time the SRTU 20 does not receive an expected signal from its associated PRTU 18, such as a poll signal during the specified polling interval, the SRTU will repeat the association procedure and associate itself with a different PRTU.

When its designated poll time arrives, the SRTU 20 turns on its transceiver 206, selects the designated frequency channel and waits to be polled. The PRTU's 18 poll request message to the SRTU 20 preferably includes the latest value of its real time clock, which is saved by the SRTU as the current network time. Also included is the (possibly modified) poll time and poll interval to be used for the next request. After receiving the poll request, the SRTU 20 transmits the operational data it has gathered to the PRTU 18. After transmitting its operational data and waiting for a short specified time interval for possible return command signal, or when the polling time interval expires without a poll request, the SRTU 20 goes back into low power mode. A SRTU 20 operating in this mode and reporting once per day will have an expected battery life of 15-20 years.

PRTUs 18 are similar to SRTUs 20 but are designed to operate their radios on a much greater duty cycle. For this reason, the battery 210 of a PRTU 18 is preferably a rechargeable battery. The PRTU 18 also comprises a solar panel 214 operatively connected to the battery 210. The PRTU 18, like the SRTU 20, is preferably of compact size, sufficient to be located at and operatively connect to a utility meter 200. More preferably, the PRTU 18 comprises the box like housing 212 with an open interior for housing electronics such as the microprocessor 204, the transceiver 206, and the antenna 208. A removable lid on the housing 212 allows for access to the electronics. The solar panel 214 is secured to the lid, or alternatively to another side of the housing 212.

An optional feature of PRTUs 18 is the ability to add one or more analog sensor inputs 216. A pressure transducer, for example, may be used to monitor the line pressure at critical points in the distribution system. If the pressure falls below a preset level, then reports including the current pressure value are generated each time the pressure changes by a specified amount. Additionally, a cathodic protection device could be monitored and its voltage output reported. Data from these or other sensors could be provided to the PRTU 18 via the analog input 216. One skilled in the art will appreciate such an analog sensor input could also be part of a SRTU 20.

When a PRTU 18 is installed, the PRTU begins periodically broadcasting a hello message in order to discover all neighboring PRTUs or data collection units (DCUs) 14. In response to the hello message, the neighbor PRTU 18 or DCU 14 will respond with the neighbor's current real-time clock value and a hop count to each DCU in the network. A DCU 14 neighbor will respond by sending a zero hop count to indicate it is a DCU. A neighbor PRTU 18 will respond by also providing its polling information for when it contacts associated SRTUs 20 and a time slot used to report collected operational data to a DCU 14. Hop tables may also be communicated along with a list of associated SRTUs 20 so that information about the network is shared among the PRTUs 18. The PRTUs 18 will thus form an ad-hoc network that is used to transmit the data to the DCUs 14.

Once all neighboring devices have been discovered, the newly installed PRTU 18 randomly picks a reporting time slot, making sure it does not duplicate that of any of its neighbors. Preferably, a reporting time slot is a one minute period out of the 24 hour day during which the PRTU 18 transmits its accumulated operational data reports to its respective DCU 14. Accumulated operational data preferably comprises all collected data, including system status, errors, and analog sensor inputs. Operational data is obtained from associated SRTUs 20 when the PRTU 18 polls the SRTUs for the data during the aforementioned assigned polling interval. A PRTU 18 may assign more than one SRTU 20 to a polling interval and expect to receive data from multiple SRTUs during the polling interval. If a PRTU 18 does not receive a data transmission from any SRTU 20 during a polling interval as anticipated, the PRTU will preferably send an additional polling request.

Each PRTU 18 sends its operational data report message to the neighbor PRTU with the lowest DCU 14 hop count so that eventually, the message arrives at the DCU. PRTU 18 communications are preferably acknowledged by the recipient to ensure the integrity of transmissions. This routing method is a special case of the standard Distance Vector Routing protocols based on the Bellman-Ford algorithm. In this case, the only destinations of interest are the DCUs 14, so each routing table is a subset of that used in a fully connected network. The random selection of reporting time slots helps to minimize collisions, but does not eliminate them. Thus, if a transmission fails, the PRTU 18 preferably delays for a random time interval, waits for a clear channel when other RTUs 12 are not transmitting, and then tries to resend its transmission. A predetermined block of time slots is preferably reserved for DCU 14 initiated transmissions such as time synchronization broadcasts and polling schedule changes.

The network preferably comprises a plurality of DCUs 14, each of which communicates with a plurality of PRTUs 18 as described above. Each DCU 14 preferably comprises an industrial PC, a spread spectrum transceiver for communicating to lower levels (RTUs) 12 in the network 10, and a means for communicating with the Host Computer 16. The means for communicating with the Host Computer 16 may be a radio link, a GSM data phone connection, a power line carrier, or any existing WAN infrastructure. In the preferred embodiment, the total area to be covered will be divided up into regions, with each region being assigned a different hop table in the FHSS system so that interference is minimized at the boundaries. Preferably, up to eight DCUs 14 can be deployed within a particular region to provide redundancy. Although not necessary, the performance of the DCU 14 is enhanced if it is elevated. Since there are only a few DCUs 14 in any given region, it is envisioned that a utility's existing infrastructure, such as voice radio towers could be used for supporting each DCU.

The DCUs 14 communicate operational data gathered to the Host Computer 16. The Host Computer 16 represents the highest level in the network. The Host Computer 16 comprises a processor with a database and a receiver assembly. The receiver assembly periodically receives data from the DCUs 14 and updates a database for each monitored device. The operational data received comprises a meter ID, meter usage or pulse total, optional physical parameter values, battery condition or status, and tamper indications. Data from this database is used to update billing and customer service databases of utilities as required. Provision is also made for the Host Computer 16 to transmit operational parameter changes to individual RTUs 12. In this way the network 10 and the RTUs 12 of the present invention are configurable. This is accomplished by having each PRTU 18 transmit its local routing table and list of associated SRTUs 20 to the Host Computer 16 whenever it is updated. This allows the Host Computer 16 to define a route to any RTU 12 and to communicate with it using a message format which contains embedded routing information.

The present invention also contemplates implementation of failure recovery mechanisms for communications among the nodes of the network. For example, if a SRTU 20 does not receive a data request from its associated PRTU 18 during the assigned polling time interval, the SRTU disassociates itself from its PRTU and begins the process of associating itself with another PRTU, as indicated by representative communication lines 30 (shown in FIG. 1). The SRTU 20 may wait for a specified number of reporting periods or days to receive a data request. Preferably, the SRTU 20 will miss only a single reporting period in the event of a PRTU 18 failure.

Since each PRTU 18 must be within range of at least one other PRTU or a DCU 14 for network 10 communications to be made, a SRTU 20 will normally be within range of at least two PRTUs. In order to provide this redundancy at boundaries of the coverage area, extra PRTUs 18 may have to be installed. The design of the system allows PRTUs 18 to be added wherever they are required to provide redundancy or to solve communications problems caused by the local terrain.

Should a SRTU 20 fail, its associated PRTU 18 will include a failure status for that meter unit which is communicated in the report that the PRTU subsequently sends to the DCU 14. This will then be passed to the Host Computer 16, where an exception report can be generated.

When a PRTU 18 is attempting to forward a message with operational data and the selected neighbor is unavailable, the PRTU may attempt to communicate the data to another PRTU selected from the remaining neighbors (excluding the neighbor that originated the message). This process is repeated until the message is successfully transmitted or there are no more neighbors to select. If the message cannot be forwarded, the PRTU 18 resets its DCU 14 hop distance to “unknown” and sends a data relay failure message back to the originating neighbor. The originating neighbor may then employ a similar process to attempt to route the message along a different path. Whenever a PRTU 18 detects a change in its hop distance to any DCU 14, it broadcasts the change to its neighbors so that they can update their routing table. If this changes a neighbor's hop distance, then the affected neighbor follows the same procedure, so that eventually, all the routing tables are updated.

If a DCU 14 fails, any PRTU 18 which was attempting to communicate with the failed DCU will broadcast a DCU status message which is propagated throughout the network 10. The status message is used to indicate to each PRTU 18 that routing tables must be updated as quickly as possible. When the ICU 14 comes back on line, it broadcasts a DCU status message. This status message causes neighboring PRTUs 18 to update and then broad their new routing table information.

Finally, if the communications link between a DCU 14 and the Host Computer 16 fails, the system 10 provides two options for recovery. Preferably, one or more backup links may be provided and can be used. Alternatively, the data may be retrieved manually by inserting a USB flash disk drive into a USB port on the DCUs 14. This will be detected automatically and all unreported data will be copied to the disk.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

1. A multi-tiered communications network for an automated utility meter reading system, the communications network comprising:
a plurality of terminal units, each terminal unit operatively coupled to a utility meter and each terminal unit comprising:
a sensor assembly adapted to detect operational data of the utility meter operatively coupled to the terminal unit;
a data transmitter adapted to transmit the operational data; and
a terminal receiver assembly adapted to receive communications;
at least one primary unit each primary unit operatively coupled to a utility meter and each primary unit comprising:
a sensor assembly adapted to detect operational data of a utility meter operatively coupled to the primary unit;
a primary receiver assembly adapted to receive the terminal unit operational data from at least one of the plurality of terminal units; and
a primary transmitter adapted to send command information to the at least one terminal unit and to transmit the operational data from the sensor assembly and the terminal unit operational data;
at least one data collection unit comprising a data receiver assembly adapted to receive the operational data from at least one primary unit and a collection unit transmitter adapted to send command information to the at least one primary unit;
wherein each terminal unit associates itself with a particular primary unit by receiving command information from the particular primary unit, the command information comprising a polling time, a polling interval, and a frequency channel number,
such that if a particular terminal unit fails to communicate with its associated primary unit at the polling time, then the particular terminal unit associates itself with a different unit.

2. The network of claim 1 wherein each of the plurality of primary units maintains a routing table comprising the hop distance to each data collection unit for the primary unit and any neighbor primary units; and
wherein each of the plurality of primary units identifies a reporting time slot, the time slot being exclusive of any time slot of any neighbor primary units; and
wherein the operational data transmitted from a particular primary unit is transmitted to the data collection unit by relay through other primary units using an entry in the routing table.

3. The network of claim 2 wherein the data collection unit or the primary unit transmits a data received signal when the operational data is received.

4. The network of claim 3 wherein the particular primary unit transmits the operational data after a delay of a random amount of time if a data received signal is not received.

5. The network of claim 3 wherein the particular primary unit transmits the operational data using a second entry in the routing table if a data relay failure message is received.

6. The network of claim 1 wherein selected primary units further comprises at least one analog sensor input adapted to receive data from an analog sensor.

7. A method for communicating information in an automated meter reading system, the method comprising:
transmitting an association signal from each of a plurality of terminal units;
transmitting a command signal from a single primary unit to a particular terminal unit in response to receiving the association signal from the particular terminal unit, the command signal comprising a poll time and a poll interval;
transmitting a polling signal from the primary unit to the particular terminal unit at the poll time;
transmitting a data signal from the particular terminal unit to the primary unit in response to the polling signal; and
transmitting a second association signal from the terminal unit if a polling signal is not received at the terminal unit.

8. The method of claim 7 further comprising the steps of:
initiating a receiver at the particular terminal unit when the poll time is reached;
placing the particular terminal unit in a low power mode after transmitting the data signal.

9. The method of claim 8 wherein the data signal comprises a meter ID, a meter pulse total, a battery condition status, and a tamper status.

10. The method of claim 7 wherein the polling, signal comprises a clock time.

11. The method of claim 7 wherein the command signal further comprises a frequency channel number and a clock time.
